(19) United States
(12) Patent Application Publication
(10) Pub. No.: US 2016/0132286 A1
(43) Pub. Date: May 12, 2016

(54) METHOD, APPARATUS AND SYSTEM FOR MULTIMEDIA PLAYBACK CONTROL

(71) Applicant: Anhui Huami Information Technology Co., Ltd., Hefei (CN)

(72) Inventors: Haocheng WU, Anhui (CN); Hui WANG, Anhui (CN)

(21) Appl. No.: 14/934,383

(22) Filed: Nov. 6, 2015

(30) Foreign Application Priority Data
Nov. 10, 2014 (CN) 201410631054.8

(51) Int. Cl. G06F 3/16; G06F 3/0488; G06F 1/16

(52) U.S. Cl. CPC G06F 3/165; G06F 1/163; G06F 3/0488

(57) ABSTRACT

Methods, apparatuses and systems for control of multimedia playback, comprising receiving an instruction data packet from a wearable smart device, wherein the instruction data packet includes a gesture instruction obtained by the wearable smart device; according to a correspondence relation between the gesture instruction and a playback control instruction, retrieving the playback control instruction associated with the gesture instruction; controlling multimedia playback according to the playback control instruction. By receiving the gesture instruction from the wearable smart device and retrieving the playback control instruction associated with the gesture instruction to control multimedia playback, a user may control the multimedia playback by gestures only, without interacting with any button.

### CROSS REFERENCE TO RELATED APPLICATION

This application claims priority to Chinese patent application no. 201410631054.8, filed Nov. 10, 2014, which is incorporated herein by reference in its entirety.

### TECHNICAL FIELD

The present disclosure generally relates to multimedia technologies, and more particularly, to methods, apparatuses and systems for multimedia playback control.

### BACKGROUND

Many users are accustomed to listening to music using smart phones, generally with earphones in scenarios such as walking, exercising, driving and the like, during which playback control is needed, including pause, play, skip to the next track and so forth. Therein a user needs to press or touch a corresponding button, usually configured to be virtually displayed on a screen of a smart phone or physically located on an earphone with controls, to send instructions of pause, play, or skip.

However, although the above-mentioned methods enable the user to control the music playback at will, there is still inconvenience. For instance, when a phone in a pocket is playing music, the user needs to take it out of the pocket to press or touch a corresponding button for playback control, which causes inconvenience and wastes time for current activity; when the user is listening to music during an exercise, it causes more inconvenience to take the phone out of the pocket for playback control, even for a case in which an earphone with controls is used wherein a button on the earphone still needs to be pressed, thus interfering the user's current exercise as well as wasting time; and when in a karaoke party, the user has to approach the karaoke machine for playback control, being very inconvenient.

### SUMMARY

Disclosed herein are implementations of methods, devices and systems for multimedia playback control. In one aspect, the present disclosure includes a method for multimedia playback control. In another aspect, the present disclosure includes a multimedia player comprising a reception module, a retrieval module and a control module; a wearable device comprising a monitor module, a decision module and a first transmission module; and a system for multimedia playback control comprising a multimedia player and a wearable device. The embodiments or implementations are configured as executable computer program instructions stored in computer readable and/or writable storage.

Features and advantages of the present disclosure will be set forth in the description thereof that follows, or will be apparent from or by practice of the disclosure.

### BRIEF DESCRIPTION OF THE DRAWINGS

The description here makes reference to the accompanying drawings wherein like reference numerals refer to like parts throughout the several views, and where:

FIG. 1 is a flowchart of a method for multimedia playback control according to implementations in this disclosure;

FIG. 2 is a flowchart of a method for multimedia playback control according to implementations in this disclosure;

FIG. 3 is a flowchart of a method for multimedia playback control according to an exemplary implementation in this disclosure;

FIG. 4 is a block diagram of a device for multimedia playback control according to implementations in this disclosure;

FIG. 5 is a block diagram of a device for multimedia playback control according to implementations in this disclosure;

FIG. 6 is a block diagram of a retrieval module in a device for multimedia playback control according to implementations in this disclosure;

FIG. 7 is a block diagram for multimedia playback control according to implementations in this disclosure;

FIG. 8 is a block diagram of a device for multimedia playback control according to implementations in this disclosure; and

FIG. 9 is a block diagram of a system for multimedia playback control according to implementations in this disclosure.

### DETAILED DESCRIPTION OF THE PREFERRED EMBODIMENT

Example implementations of the present disclosure will be described below with reference to the accompanying drawings. The same numbers across the drawings set forth in the following description represent the same or similar elements, unless differently expressed. The implementations set forth in the following description do not represent all implementations or embodiments consistent with the present disclosure; on the contrary, they are only examples of apparatuses and methods in accordance with some aspects of this disclosure as detailed in the claims.

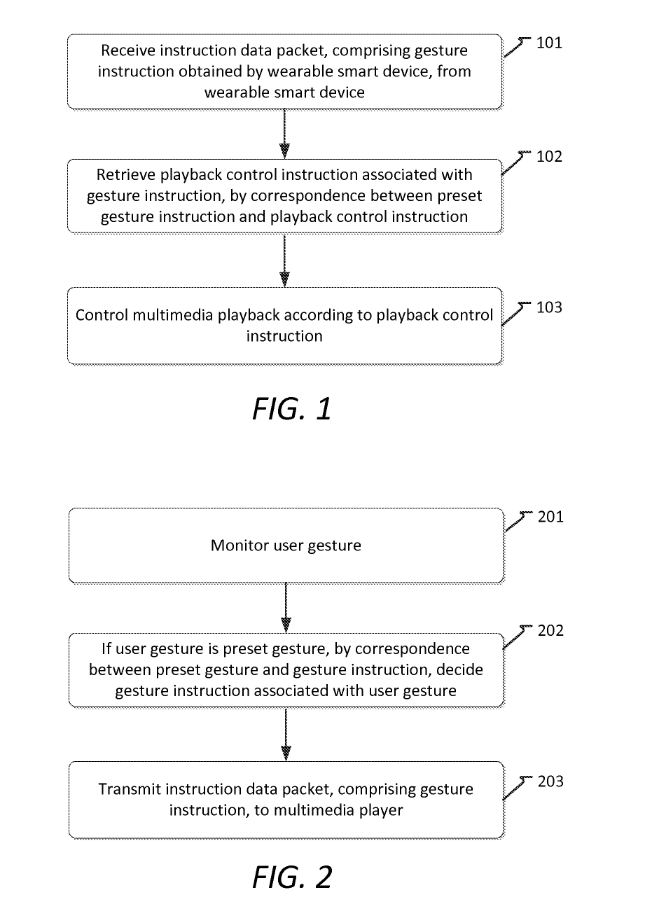

In one implementation, a method, a device and a system for convenient and swift control of multimedia playback is set forth herein. FIG. 1 is a flowchart of a method for multimedia playback control according to this implementation, being used in a multimedia player, comprising steps 101-103 set forth in the following description.

At step 101, the multimedia player receives an instruction data packet from a wearable smart device, which comprises a gesture instruction obtained by the wearable smart device.

At step 102, in accordance with a correspondence relation between the gesture instruction and a playback control instruction, the multimedia player retrieves the playback control instruction associated with the gesture instruction.

At step 103, the multimedia player controls multimedia playback according to the playback control instruction.

In the method of this implementation, the multimedia player receives the gesture instruction from the wearable smart device to retrieve the playback control instruction associated with the gesture instruction for the multimedia playback control, whereby the user may control the multimedia playback by gestures only, without interacting with any button, resulting to more convenient multimedia playback control and improved user experience.

In the aforementioned method, the multimedia player may be a cell phone, a tablet computer, a personal computer, or any terminal device with one or more functions of playing multimedia; the wearable smart device may be a smart bracelet with one or more internal Bluetooth apparatuses, which may be wore conveniently by a user.

At step 102, the correspondence relation between the gesture instruction and the playback control instruction may be preset by the user. The gesture instruction comprises occurrence, speed, or duration of the user gesture. For instance, when controlling the multimedia player to play music using the wearable smart device, a gesture instruction “snap fingers for once” is associated with a playback control instruction “pause playing”, and a gesture instruction “rotate wrist for twice within one second” is associated with a playback control instruction “skip to the next track”. The correspondence relation between the gesture instruction and the playback control instruction may be pre-stored in the multimedia player, which may retrieve the playback control instruction associated with the gesture instruction contained in an instruction data packet according to the pre-stored correspondence relation for the multimedia playback control, upon receiving the instruction data packet from the wearable smart device.

In one implementation, before step 101, steps A1-A2 are also included in the aforementioned method.

At step A1, the multimedia player establishes a wireless connection to the wearable smart device.

At step A2, upon receiving an identifier of the wearable smart device, the multimedia player stores the identifier for a matching operation between the multimedia player and the wearable smart device.

In this implementation, the wearable smart device and the multimedia player may be connected via Bluetooth, wherein the wearable smart device and the multimedia player may be matched beforehand, therefore when controlling multimedia playback, the user may control the multimedia player using the matched wearable smart device by gestures only, without interacting with any button, resulting to more convenient multimedia playback control and improved user experience.

In one implementation, at step 101, the instruction data packet received by the multimedia player further comprises the identifier of the wearable smart device; therefore step 102 may be implemented in the following description. The multimedia player firstly determines whether the identifier within the instruction data packet is any pre-stored identifier. If the identifier is one of the pre-stored identifiers, according to the correspondence relation between the preset gesture instruction and the playback control instruction, the multimedia player retrieves the playback control instruction associated with the gesture instruction.

FIG. 2 is a flowchart of a method for multimedia playback control, being used in a wearable smart device, according to one implementation in this disclosure, wherein steps 201-203 are set forth in the following description.

At step 201, the wearable smart device detects a user gesture.

At step 202, if the user gesture is any preset gesture, according to a correspondence relation between the preset gesture and a gesture instruction, the wearable smart device decides the gesture instruction associated with the user gesture.

At step 203, the wearable smart device transmits an instruction data packet, which comprises the gesture instruction, to a multimedia player.

In the method of this implementation, the wearable smart device detects the user gesture, and transmits the gesture instruction associated with the user gesture to the multimedia player, wherein the multimedia player retrieves a playback control instruction according to the gesture instruction for the multimedia playback control, whereby the user may control the multimedia playback by gestures only, without interacting with any button, resulting to more convenient multimedia playback control and improved user experience.

In this implementation, the wearable smart device (such as a smart bracelet) internally may include a Bluetooth chip and a sensor, wherein the Bluetooth chip is used to establish a wireless connection to the multimedia player, and to transmit the instruction data packet to the multimedia player; the sensor is used to monitor user gestures, for instance: the wearable smart device may include an accelerometer or a gyroscope, which may monitor user gestures in real time or by a preset frequency, such as in every two minutes, comprising speed, occurrence, and duration thereof.

The preset gesture may be “snap fingers for once”, “rotate wrist for twice within one second”, “snap fingers for twice”, and so forth. The wearable smart device detects the user gesture, and if the user gesture is any preset gesture, according to the correspondence relation between the preset gesture and the gesture instruction, the wearable smart device decides the gesture instruction associated with the user gesture; if otherwise, no operation is performed.

In one implementation, before step 201, steps B1-B2 are also included in the aforementioned method.

At step B1, the wearable smart device establishes a wireless connection to the multimedia player, wherein the wearable smart device establishes the wireless connection to the multimedia player via Bluetooth.

At step B2, the wearable smart device transmits an identifier to the multimedia player, wherein the identifier is used for a matching operation between the multimedia player and the wearable smart device.

The wearable smart device and the multimedia player may be matched beforehand; thereby the instruction data packet transmitted by the wearable smart device is ensured not to be received by another multimedia player, ensuring that the multimedia playback is accurately controlled through the wearable smart device by the user.

In one implementation, at step 203, the instruction data packet transmitted to the multimedia player by the wearable smart device also includes the identifier of the wearable smart device. Upon receiving the identifier of the wearable smart device, the multimedia player firstly determines whether the identifier is any pre-stored identifier in the multimedia player. If the identifier is one of the pre-stored identifiers in the multimedia player, the multimedia playback is controlled according to the received instruction data packet; if otherwise, no operation is performed, or an error message alert is sent.

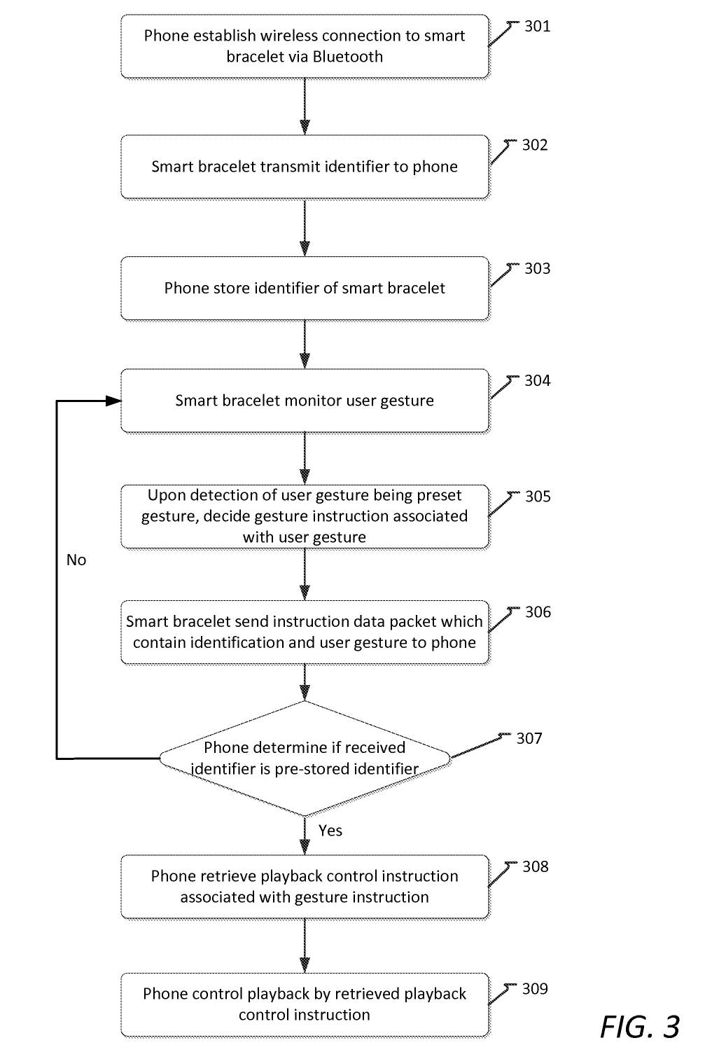

FIG. 3 is a flowchart of a method for multimedia playback control according to an exemplary implementation in this disclosure, wherein the multimedia player is a smart phone; the wearable smart device is a smart bracelet which installs a low power consumption Bluetooth chip and a sensor for monitoring user gestures. The Bluetooth chip is controlled by a controller in the smart bracelet, being able to periodically transmit an instruction data packet containing an identifier and a gesture instruction. FIG. 3 includes steps 301-309 set forth in the following description.

At step 301, the phone establishes a wireless connection to the smart bracelet via Bluetooth.

At step 302, the smart bracelet transmits an identifier to the phone.

At step 303, the phone stores the identifier of the smart bracelet.

At step 304, the smart bracelet monitors user gestures.

At step 305, upon detection of a user gesture being any preset gesture, the smart bracelet decides the gesture instruction associated with the user gesture, wherein the smart bracelet, according to a correspondence relation between the preset gesture and the gesture instruction, decides the gesture instruction associated with the user gesture. For instance, the preset gesture may be “snap fingers” or “rotate wrist for twice within one second”. When the user rotates his/her wrist for twice within one second, a gesture instruction associated with the gesture “rotate wrist for twice within one second” is decided.

At step 306, the smart bracelet transmits an instruction data packet to the phone, wherein the instruction data packet contains the identifier the user gesture.

At step 307, the phone determines whether the received identifier is any pre-stored identifier; if the received identifier is one of the pre-stored identifiers, step 308 is executed; if otherwise, step 304 is executed.

At step 308, the phone retrieves a playback control instruction associated with the gesture instruction, wherein the phone, according to the correspondence relation between the preset gesture instruction and the playback control instruction, retrieves the playback control instruction associated with the gesture instruction. For instance, a gesture instruction “snap fingers” may associate with a playback control instruction “play/pause”, a gesture instruction “rotate wrist for twice within one second” may associate with a playback control instruction “skip to the next track”.

At step 309, the phone controls the music playback according to the received playback control instruction. For instance, when the gesture instruction is “rotate wrist for twice within one second”, the phone controls the current player to skip to the next track.

In the method of this implementation, by being matched to the smart bracelet beforehand and receiving the gesture instruction from the smart bracelet, the phone retrieves the playback control instruction associated with the gesture instruction for the multimedia playback control, whereby the user may control the multimedia playback by gestures only, without interacting with any button, resulting to more convenient multimedia playback control and improved user experience.

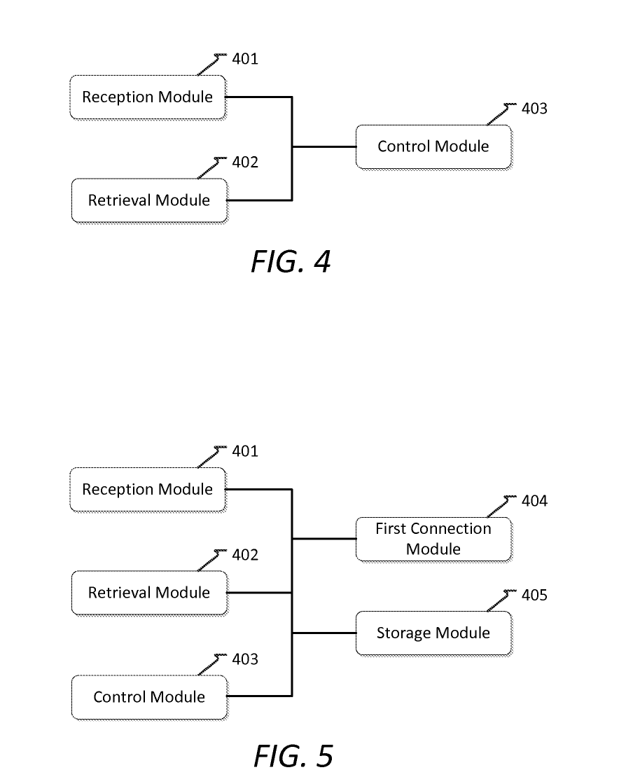

FIG. 4 is a block diagram of a device for multimedia playback control according to implementations in this disclosure, wherein the device may be a multimedia player, comprising modules 401-403 set forth in the following description.

A reception module 401 is used to receive an instruction data packet from a wearable smart device, wherein the instruction data packet contains a gesture instruction obtained by the wearable smart device.

A retrieval module, according to a correspondence relation between a preset gesture instruction and a playback control instruction, is used to retrieve the playback control instruction associated with the gesture instruction.

A control module 403 is used to control the multimedia playback according to the playback control instruction.

In one implementation, as illustrated in FIG. 5, the aforementioned device further comprises modules set forth in the following description.

A first connection module 404 is used to establish a wireless connection to the wearable smart device.

A storage module 405 is used, upon receiving an identifier from the wearable smart device, to store the identifier for a matching operation between the multimedia player and the wearable smart device.

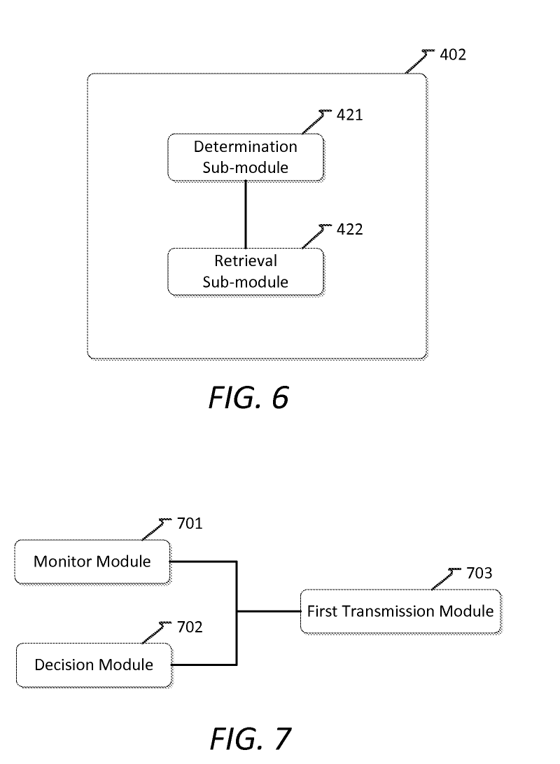

In one implementation, as illustrated in FIG. 6, the retrieval module 402 comprises:

A determination sub-module 421 for determining whether the identifier in the instruction data packet is any pre-stored identifier; and

A retrieval sub-module 422, wherein if the identifier in the instruction data packet is one of the pre-stored identifiers, according to the correspondence relation between the preset gesture instruction and the playback control instruction, the retrieval sub-module 422 retrieves the playback control instruction associated with the gesture instruction.

FIG. 7 is a block diagram for multimedia playback control according to implementations in this disclosure, wherein the device may be a wearable smart device, comprising modules 701-703 set forth in the following description.

A monitor module 701 is used to monitor user gestures.

A decision module 702 is used, if the user gesture is any preset gesture, according to a correspondence relation between the preset gesture and a gesture instruction, to decide the gesture instruction associated with the user gesture.

A first transmission module 703 is used to transmit an instruction data packet to a multimedia player, wherein the instruction data packet contains the gesture instruction.

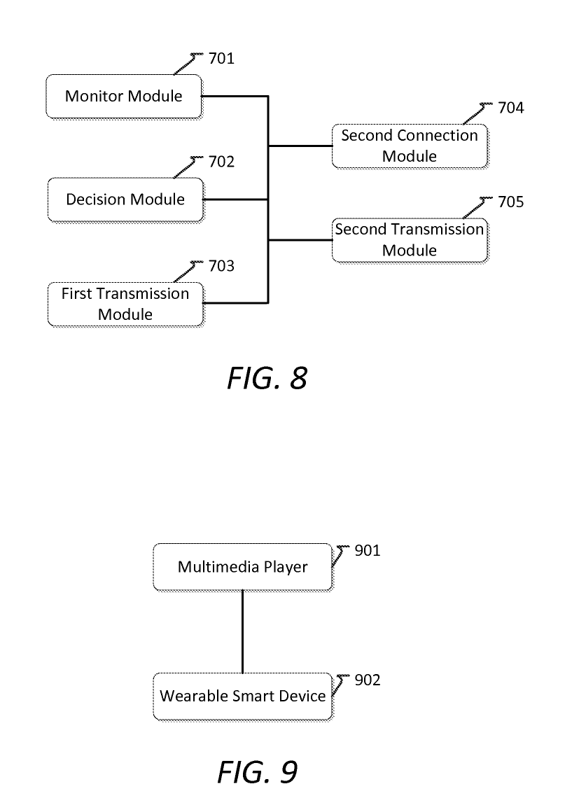

In one implementation, as illustrated in FIG. 8, the aforementioned device further comprises modules set forth in the following description.

A second connection module 704 is used to establish a wireless connection to the multimedia player.

A second transmission module 705 is used to transmit the identifier to the multimedia player for a matching operation between the multimedia player and the wearable smart device.

FIG. 9 is a block diagram of a system for multimedia playback control according to implementations in this disclosure, wherein the system comprises a multimedia player 901 and a wearable smart device 902 set forth in the following description.

The multimedia player 901 is used to receive an instruction data packet from the wearable smart device 902, wherein the instruction data packet comprise a gesture instruction obtained by the wearable smart device 902. According to a correspondence relation between a preset gesture instruction and a playback control instruction, the multimedia player 901 is used to retrieve the playback control instruction associated with the gesture instruction, for the multimedia playback control according to the playback control instruction.

The wearable smart device 902 is used to monitor user gestures. If a detected user gesture is any preset gesture, according to the correspondence relation between the preset gesture and the gesture instruction, the wearable smart device 902 decides the gesture instruction associated with the user gesture, and transmits the instruction data packet to the multimedia player 901, wherein the instruction data packet comprises the gesture instruction.

Technical specialists skilled in the art should understand that, the implementations in this disclosure may be implemented as methods, systems, or computer program products. Therefore, this disclosure may be implemented in forms of a complete hardware implementation, a complete software implementation, and a combination of software and hardware implementation. Further, this disclosure may be embodied as a form of one or more computer program products which are embodied as computer executable program codes in computer writable storage media (including but not limited to disk storage and optical storage).

This disclosure is described in accordance with the methods, devices (systems), and flowcharts and/or block diagrams of computer program products of the implementations, which should be comprehended as each flow and/or block of the flowcharts and/or block diagrams implemented by computer program instructions, and the combinations of flows and/or blocks in the flowcharts and/or block diagrams. The computer program instructions therein may be provided to generic computers, special-purpose computers, embedded computers or other processors of programmable data processing devices to produce a machine, wherein the instructions executed by the computers or the other processors of programmable data processing devices produce an apparatus for implementing the functions designated by one or more flows in the flowcharts and/or one or more blocks in the block diagrams.

The computer program instructions may be also stored in a computer readable storage which is able to boot a computer or other programmable data processing device to a specific work mode, wherein the instructions stored in the computer readable storage produce a manufactured product containing the instruction devices which implements the functions designated by one or more flows in the flowcharts and/or one or more blocks in the block diagrams.

The computer program instructions may also be loaded to a computer or another programmable data processing device to execute a series of operating procedures in the computer or the other programmable data processing device to produce a process implemented by the computer, whereby the computer program instructions executed in the computer or the other programmable data processing device provide the operating procedures for the functions designated by one or more flows in the flowcharts and/or one or more blocks in the block diagrams.

Apparently, the technical specialists skilled in the art may perform any variation and/or modification to this disclosure by the principles and within the scope of this disclosure. Therefore, if the variations and modifications herein are within the scope of the claims and other equivalent techniques herein, this disclosure intends to include the variations and modifications thereof.

What is claimed is:

1. A method for controlling multimedia playback at a multimedia player, comprising:
receiving one or more instruction data packets from a wearable smart device, wherein the one or more instruction data packets comprise a gesture instruction obtained by the wearable smart device;
in accordance with a correspondence relation between a preset gesture instruction and a playback control instruction, retrieving the playback control instruction associated with the gesture instruction; and
controlling multimedia playback in accordance with the playback control instruction.

2. The method of claim 1, wherein the receiving one or more instruction data packets from a wearable smart device, wherein the one or more instruction data packets comprise a gesture instruction obtained by the wearable smart device, further comprises:
establishing a wireless connection to the wearable smart device; and
upon receiving an identifier of the wearable smart device, storing the identifier for a matching operation between the multimedia player and the wearable smart device.

3. The method of claim 2, wherein the one or more instruction data packets comprise an identifier of the wearable smart device; and wherein in accordance with a correspondence relation between a preset gesture instruction and a playback control instruction, the retrieving the playback control instruction associated with the gesture instruction comprises:
determining whether the identifier within the one or more instruction data packets is one or more pre-stored identifiers; and
upon a determination that the identifier within the one or more instruction data packets is one of the one or more pre-stored identifiers, in accordance with the correspondence relation between the preset gesture instruction and the playback control instruction, retrieving the playback control instruction associated with the gesture instruction.

4. A method for controlling multimedia playback at a wearable smart device, comprising:
monitoring one or more user gestures;
upon a determination that a user gesture is a preset gesture, in accordance with a correspondence relation between the preset gesture and a gesture instruction, determining the gesture instruction associated with the user gesture; and
transmitting one or more instruction data packets to a multimedia player, wherein the one or more instruction data packets comprise the gesture instruction.

5. The method of claim 4, wherein the monitoring one or more user gestures further comprises:
establishing a wireless connection to the multimedia player; and
transmitting an identifier to the multimedia player, wherein the identifier is used for a matching operation between the multimedia player and the wearable smart device.

6. The method of claim 5, wherein the one or more instruction data packets further comprise an identifier of the wearable smart device.

7. An apparatus for multimedia playback control, comprising:
a reception module, wherein the reception module is configured to receive one or more instruction data packets from a wearable smart device, wherein the one or more instruction data packets comprise a gesture instruction obtained by the wearable smart device;
a retrieval module, wherein in accordance with a correspondence relation between a preset gesture instruction and a playback control instruction, the retrieval module is configured to retrieve the playback control instruction associated with the gesture instruction; and
a control module, wherein the control module is configured for the multimedia playback control in accordance with the playback control instruction.

8. The apparatus of claim 7, further comprising:
a first connection module, wherein the first connection module is configured to establish a wireless connection to the wearable smart device; and
a storage module, wherein upon receiving an identifier of the wearable smart device, the storage module is configured to store the identifier for a matching operation between a multimedia player and the wearable smart device.

9. The apparatus of claim 8, wherein the retrieval module comprises:
a determination sub-module, wherein the determination sub-module is configured to determine whether the identifier within the one or more instruction data packets is any of one or more pre-stored identifiers; and
a retrieval sub-module, wherein upon a determination that the identifier within the one or more instruction data packets is one of the one or more pre-stored identifiers, in accordance with the correspondence relation between the gesture instruction and the playback control instruction, the retrieval sub-module is configured to retrieve the playback control instruction associated with the gesture instruction.

10. A apparatus for multimedia playback control, comprising:
a monitor module, wherein the monitor module is configured to monitor one or more user gestures;
a decision module, wherein upon a determination that a user gesture is a preset gesture, in accordance with a correspondence relation between a preset gesture and a gesture instruction, the decision module is configured to determine the gesture instruction associated with the user gesture; and
a first transmission module, wherein the first transmission module is configured to transmit one or more instruction data packets to a multimedia player, wherein the one or more instruction data packets comprise the gesture instruction.

11. The apparatus of claim 10, further comprising:
a second connection module, wherein the second connection module is configured to establish a wireless connection to a wearable smart device; and
a second transmission module, wherein the second transmission module is configured to transmit an identifier to the multimedia player, wherein the identifier is configured for a matching operation between the multimedia player and the wearable smart device.

12. A system for multimedia playback control, comprising a multimedia player and a wearable smart device, wherein:
the multimedia player is configured to receive one or more instruction data packets from the wearable smart device, wherein the one or more instruction data packets comprise a gesture instruction obtained by the wearable smart device; in accordance with a correspondence relation between the gesture instruction and a playback control instruction, to retrieve the playback control instruction associated with the gesture instruction; and to control the multimedia playback in accordance with the playback control instruction; and
the wearable smart device is configured to monitor one or more user gestures, wherein upon a determination that a user gesture is a preset gesture; in accordance with a correspondence relation between the preset gesture and the gesture instruction, to determine the gesture instruction associated with the user gesture; to transmit the one or more instruction data packets to the multimedia player, wherein the one or more instruction data packets comprise the gesture instruction.
